(19) United States
(12) Patent Application Publication
(10) Pub. No.: US 2015/0089374 A1
(43) Pub. Date: Mar. 26, 2015

(54) NETWORK VISUALIZATION SYSTEM AND METHOD

(71) Applicant: Cyan Inc., Petaluma, CA (US)

(72) Inventor: FNU Nagarajan, Albany, CA (US)

(73) Assignee: Cyan Inc., Petaluma, CA (US)

(21) Appl. No.: 14/033,310

(22) Filed: Sep. 20, 2013

(51) Int. Cl. H04L 12/24

(52) U.S. Cl. CPC H04L 41/12
USPC 715/734

(57) ABSTRACT

A system and method for visualizing a network topology is disclosed that includes defining a tree representation of a network topology wherein a highest level of detail includes representations of nodes of the network and connections therebetween and lower levels include nodes representing clusters of nodes in a lower level of detail and connections therebetween. The tree may then be traversed to identify selected nodes lying within a level-specific threshold of a viewpoint. Metalinks having as either of their endpoints non-selected nodes are identified and heterogeneous links are generated that define connections between selected descendants of the non-selected nodes. A graphical representation of the network topology may be generated that includes representations of the selected nodes, the heterogeneous links and connections between selected nodes. The graphical representation may then be transmitted for display to a user.

### BACKGROUND

1. Field of the Invention

This invention relates to systems and methods for providing a human-understandable visualization of a network topology.

2. Background of the Invention

Modern networks can be very complex. For example, a large corporation or organization with a large number of interconnected facilities may include a very large number of interconnected devices (hereinafter “nodes”). It can be difficult to visualize such a network. A high-level view of the network may include too much information and be useless for understanding the network as well as require a large amount of processing to render.

Algorithms exist to view information in different levels of details. For example, different amounts of detail may be displayed for different views. Some map viewing applications allow one to view maps with different levels of details of a region by zooming in or out of the region. However, at any one time, only one level of detail is shown. In instances where a viewing angle is other than directly downwards, distant objects may be shown in excess and unviewable detail or close objects may be shown with too little detail.

In the paper entitled “A Client-Server-Scenegraph for the Visualization of Large and Dynamic 3D Scenes”, Jörg Sahm and Ingo Soetebier, Journal of WSCG (2004) (hereinafter “Sahm”), a solution is proposed wherein objects closer to a viewpoint are shown in greater detail and objects further from a viewpoint are simultaneously shown in less detail.

This approach has difficulty with large networks because large network also contain a large number of long links which can cross multiple level of detail boundaries and furthermore, links are not independent objects but are intimately related to the end nodes which they connected.

This application is directed to an improved algorithm for visualizing networks in which different portions of the same network are shown in different level of detail in the same image.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network that may be visualized according to methods in accordance with embodiments of the present invention;

FIG. 2 is a schematic block diagram of an exemplary computing device;

FIG. 3 is a process flow diagram of a method for generating a quadtree;

FIGS. 4A through 4C are diagrams of quadnodes in accordance with an embodiment of the present invention;

FIG. 5 is a process flow diagram of a method for generating a selected set of nodes based on location relative to a viewpoint in accordance with an embodiment of the present invention;

FIG. 6 is a side view illustrating viewer position with respect to reference surface in accordance with an embodiment of the present invention;

FIG. 7 is a process flow diagram of a method for generating heterogeneous links in accordance with an embodiment of the present invention;

FIG. 8 is a perspective view of a network showing a lowest level of detail in accordance with an embodiment of the present invention;

FIG. 9 is a perspective view of a network showing both high and low level of detail in accordance with an embodiment of the present invention; and

FIGS. 10A through 10C are top views of representations of nodes of a network in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods. Accordingly, the invention has been developed to provide a system for visualizing network topology, the system comprising one or more processors and one or more memory devices operatively coupled to the one or more processors. The one or more memory devices storing executable and operational data effective to cause the one or more processors to define a tree representation of a network topology wherein a lowest level includes representations of nodes of the network and connections therebetween and upper levels include nodes representing clusters of nodes in a lower level and connections therebetween, each node having a location associated therewith. The tree may then be traversed to identify selected nodes lying within a level-specific threshold of a viewpoint. The tree may be traversed a second time to identify selected nodes having connections to non-selected nodes. Alternatively, nodes with connections to non-selected nodes may be identified during the first traversal of the tree. Heterogeneous links may be generated that define connections between the identified selected nodes and other selected nodes that are descendants of non-selected nodes that are an endpoint of a link connected to a selected node. A graphical representation of the network topology may be generated that includes representations of the selected nodes, the heterogeneous links and connections between selected nodes. The graphical representation may then be transmitted for display to a user.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Python, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

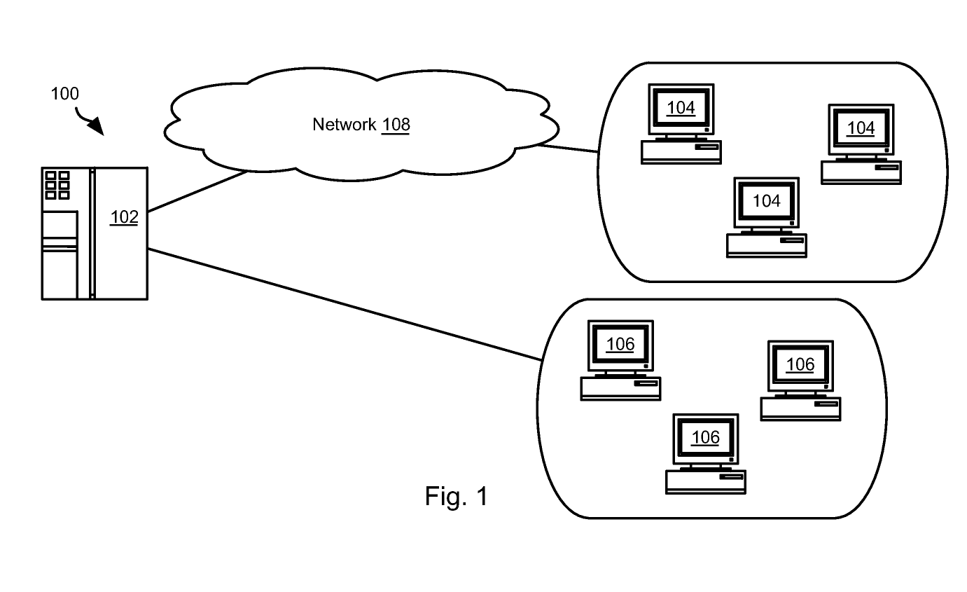

FIG. 1 illustrates a system 100 in which methods described hereinbelow may be implemented. The system 100 may include one or more server systems 102 that may each be embodied as one or more server computers each including one or more processors that are in data communication with one another. The server system 102 may be in data communication with one or more workstations 104 at first location and one or more workstations 106 that may be at a different location. The locations 104, 106 may each be node of a network and as a cluster may also define a node of a network. The workstations 104, 106 may be embodied as any network connected computer device such as a desktop computer, laptop computer, tablet computer, smart phone, or the like.

Some or all of the server 102, workstations 104, and user workstations 106 may communicate with one another by means of a network 108. The network 108 may be embodied as a peer-to-peer connection between devices, a connection through a local area network (LAN), WiFi network, the Internet, or any other communication medium or system.

The illustrated system 100 is just one example of a networked system that may be visualized according to method described herein. The number of clusters of workstations 104, 106, servers, networks 108, and the arrangement and connections between these components may have any arbitrary configuration and may be organized according to any principle for designing such networks. As noted above, large networks may be readily visualized according to the methods disclosed herein.

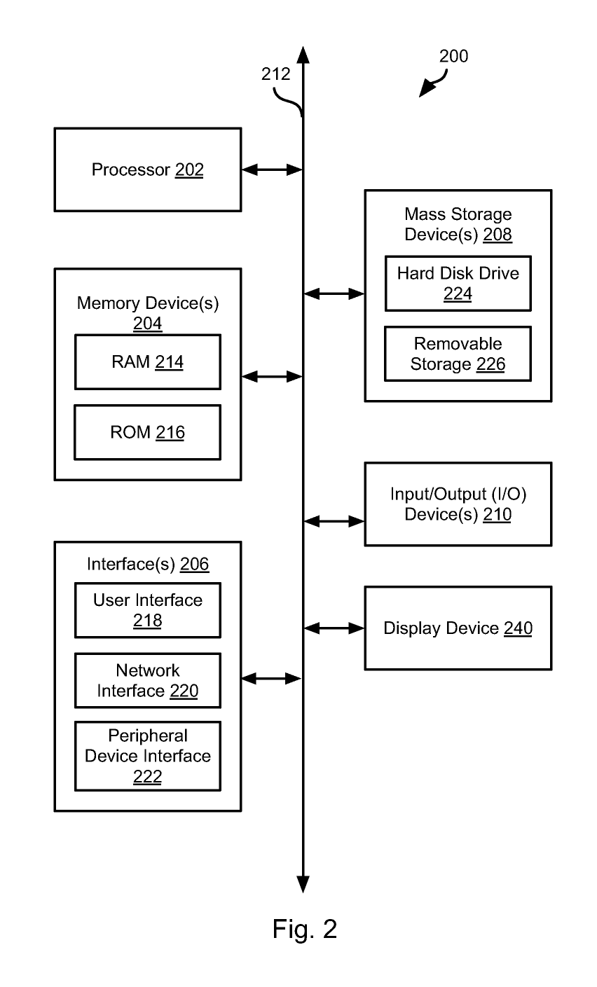

FIG. 2 is a block diagram illustrating an example computing device 200. Computing device 200 may be used to perform various procedures, such as those discussed herein. A server system 102, workstation 104, and workstation 106 may have some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, tablet computer and the like.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more user interface elements 218. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, and I/O device(s) 210 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

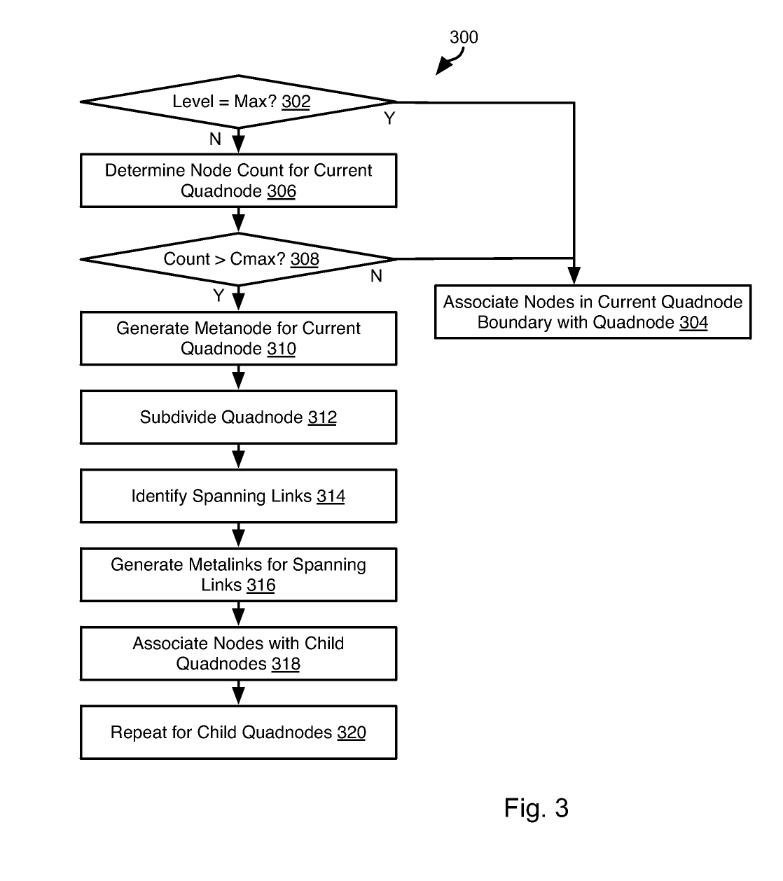

Referring to FIG. 3, a method 300 may be executed by a computing device in order to visualize a network topology. The method 300 may be executed with respect to a network topology and is particularly useful for network topologies including a large number of network nodes having locations associated therewith, the locations being distributed over a large areas and connections between network nodes that likewise span a large distance. The method 300 organizes network nodes of the network topology into a quadtree. As an initial step a root quadnode (hereinafter root node) may be defined that encompasses the locations of all the network nodes or all network nodes that are of interest and are to be visualized using the methods disclosed herein. For purposes of this disclosure a “quadtree” and “quadnodes” are discussed that are organized in a quadtree wherein a quadnode has no more than four child quadnodes. However, it is to be understood that quadnode may refer to a tree having any number of child nodes for a given node. Also, although a quadnode may have up to four (or some other number) of child nodes, in some instances a quadnode may have less than this number.

The method 300 may begin with a current quadnode set to refer to the root node. The illustrated steps of the method 300 may proceed with respect to a current node up to a certain depth below the root node. Accordingly, the method 300 may include evaluating whether the current quadnode is at a maximum depth below the root node. If so, then any network nodes of the network topology located within an area defined by the current quadnode may be associated 304 with the current quadnode. As noted above, the root node has an area encompassing the entire network or portion of the network being visualized. Child quadnodes of the rootnode represent portions of this area. For example, the area may be divided into N (e.g. N=4) areas, each area associated with a quadnode. Likewise, all but lowest level quadnodes (“leaf” quadnodes) may have the area thereof subdivided into N areas and these subdivisions associated with child quadnodes thereof. The area associated with a quadnode has both an extent and a location with respect to the network topology. In some embodiments, a quadnode location may be represented by a location of a center of the area represented by the quadnode.

If the current node is not found 302 to be at a maximum depth level, then the method 300 may include determining 306 a node count for the current quadnode, e.g. counting the number of network nodes having locations within the area associated with the current quadnode. If this count is found 308 to be less than or equal to a maximum count, the nodes within the area defined by the quadnode may be associated 304 with that quadnode. In some embodiments, the maximum count is the same as the maximum number of child nodes of a quadnode, e.g. four for quadnodes having up to four child quadnodes.

If the count is found 308 to be greater than a maximum count, then the method 300 may include generating 310 a metanode and associating the metanode with the current quadnode. A metanode may be an entity that will be used to represent the nodes determined at step 306 in the method described herein. The metanode may have a location defined as a center of the current quadnode, e.g. the location of the quadnode, or may represent an average location of the network nodes located within the current quadnode.

The method 300 may further include dividing 312 the area of the current quadnode to obtain N sub-areas each having a center location within the area of the current quadnode and together covering the entire area of the current quadnode. For example, a rectangular area may be divided into four smaller rectangles. Child quadnodes may be defined each having one of the sub-areas associated therewith.

The method 300 may further include identifying 314 spanning links. Spanning links may be links between network nodes located within the area defined by the current quadnode that have a first end located within a first child quadnode of the current quadnode and a second end located within a second child node of the current quadnode. For a given pair of child quadnodes having one or more spanning links therebetween, a metalink may be generated 316. The metalink may define as ends thereof the locations of the pair of child nodes, e.g. the center thereof of some other coordinate used to define the location thereof. The metalink may also store information describing the one or more spanning links between the pair of child nodes. For example, the locations of first and second ends of each of the spanning links.

The method 300 may further include associating with the child quadnodes the network nodes determined at step 306 to lie within the current quadnode. For example, for each child quadnode, the network nodes that lie within the area defined by the each child quadnode may be associated with the child quadnode. Likewise, any non-spanning links between these network nodes may also be associated with the each child quadnode.

The method 300 may then be repeated 320 for each of the child quadnodes. It is possible that no network nodes lie within one or more of the child quadnodes of the current quadnode. Accordingly, the method 300 may be repeated 320 only for those quadnodes having network nodes associated 318 therewith. If a child quadnode has no network nodes associated therewith, it may be deleted or otherwise not be included in the quadtree generated according to the method. For example, up until step 318 where nodes are actually associated with a child quadnode, a child quadnode may not be created, but rather the area that a child quadnode would occupy is used to determine whether a network node is located therein.

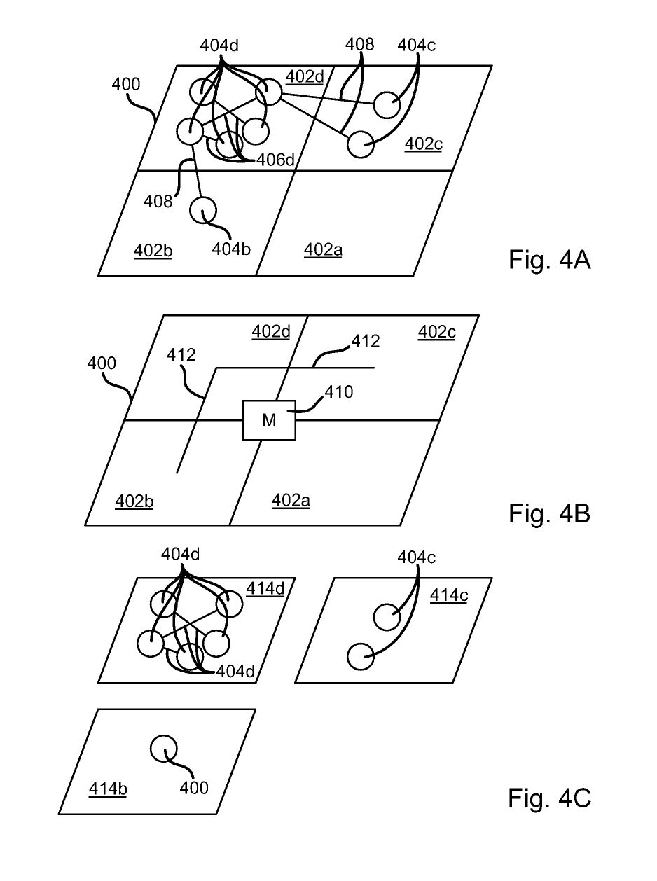

FIGS. 4A through 4C illustrate an example of how the method 300 of FIG. 3 may proceed. A quadnode 400 may define and area divisible into quadrants 402a-402c, or some other division. A plurality of network nodes 404b, 404c, 402d are located within the area defined by the quadnode 400. As shown in FIG. 4A, the nodes 406d lie entirely within the quadrant 402d and a plurality of non-spanning links 406d connect some of the nodes 406d to one another. Likewise, some spanning links 408 connect a node 404b lying in quadrant 402b to a node 404d in quadrant 402d and connect two nodes 404c in quadrant 402c to a node 404d.

As described above, the number of network nodes within the quadnode 400 may be counted, eight in the illustrated example. This exceeds the maximum node count, four in this example. Accordingly, as shown in FIG. 4B, a metanode 410 may be defined and associated with the quadnode 400. Likewise, metalinks 412 may be generated for the spanning links 408.

Referring to FIG. 4C, child quadnodes 414b-414d may be generated and the nodes 404c-404d associated with the corresponding quadnodes. As is shown, a quadnode is not generated for quadrant 402a inasmuch as no network nodes lie in this quadrant. Child quadnodes 414b, 414c have less than four quadnodes and therefore no further processing may be performed with respect to them. However, the child quadnode 414d has five network nodes 404d associated therewith. Accordingly, the method may be repeated to divide the child quadnode 414d into two or more grandchild quadnodes.

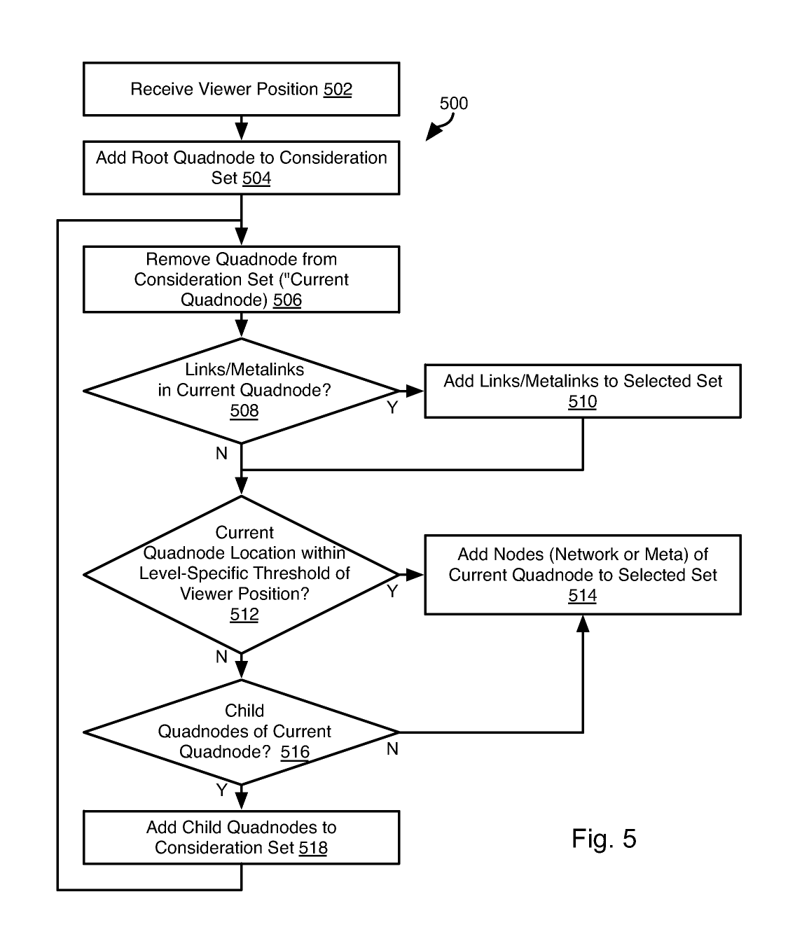

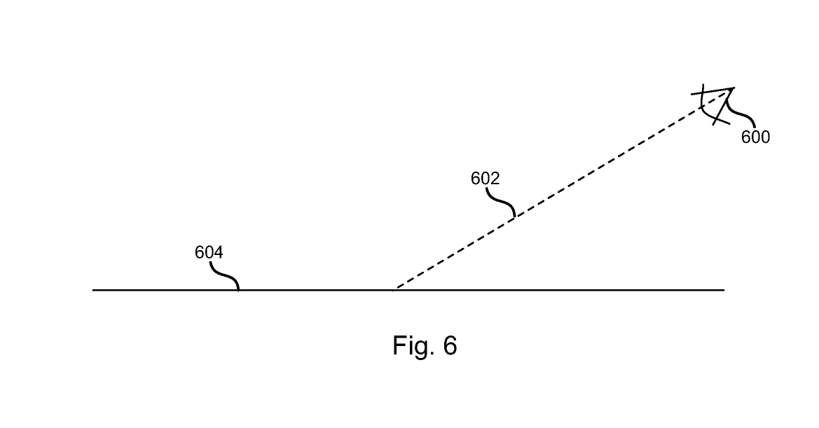

Referring to FIG. 5, the illustrated method 500 may be used to select network nodes and metanodes for display to a user. Referring to FIG. 6, the method 500 may be executed for a given position of a viewpoint 600 having a line of sight 602 directed at a reference plane 604. All of the network nodes may lie within the reference plane 604. Alternatively, the network nodes may have three-dimensional locations and lie above or below the reference plane 604.

Referring again to FIG. 5, the method 500 may include receiving 502 a viewer position with respect to the network. A root node (root quadnode) may be added 504 to a consideration set. The consideration set may be understood as a set of quadnodes of the quadtree that are to be processed according to the following steps of the method 500.

The method 500 may include removing 506 a quadnode from the consideration set (the “current quadnode) and evaluating 508 whether the current quadnode includes any links or metalinks, if so, these links are added 510 to a selected set of links, metalinks, nodes, and metanodes used to visualize a network.

The method 500 may include evaluating 512 whether the current quadnode is within a level specific threshold of the viewer position. As noted above, each quadnode has a position associated therewith, such as the center thereof. Accordingly, the distance to the viewer position may be the distance between this position and the viewer. The threshold used for comparison may depend on the level of the current quadnode in the quadtree. For example, for the root node (level 0) the threshold may be X, for the child quadnodes of the root node (level 1) the threshold may be X/2, for level 2 quadnodes, the threshold may be X/4, and so on up to X/(2̂Nmax), where Nmax is the deepest level of the quadtree (highest level of detail).

If the current quadnode has a position greater than the level-specific threshold from the viewpoint, any nodes or a metanode associated with the current node are added 514 to the selected set. If not, then the method 500 may include evaluating 516 whether the current quadnode has any child quadnodes, if not any network nodes associated with the current quadnode are added 514 to the selected set. If the current quad node is found 516 to have child quadnodes, these quadnodes are added 518 to the consideration set and the method continues at step 506 with respect to the current state of the consideration set. The method 500 end when no quadnodes remain in the consideration set.

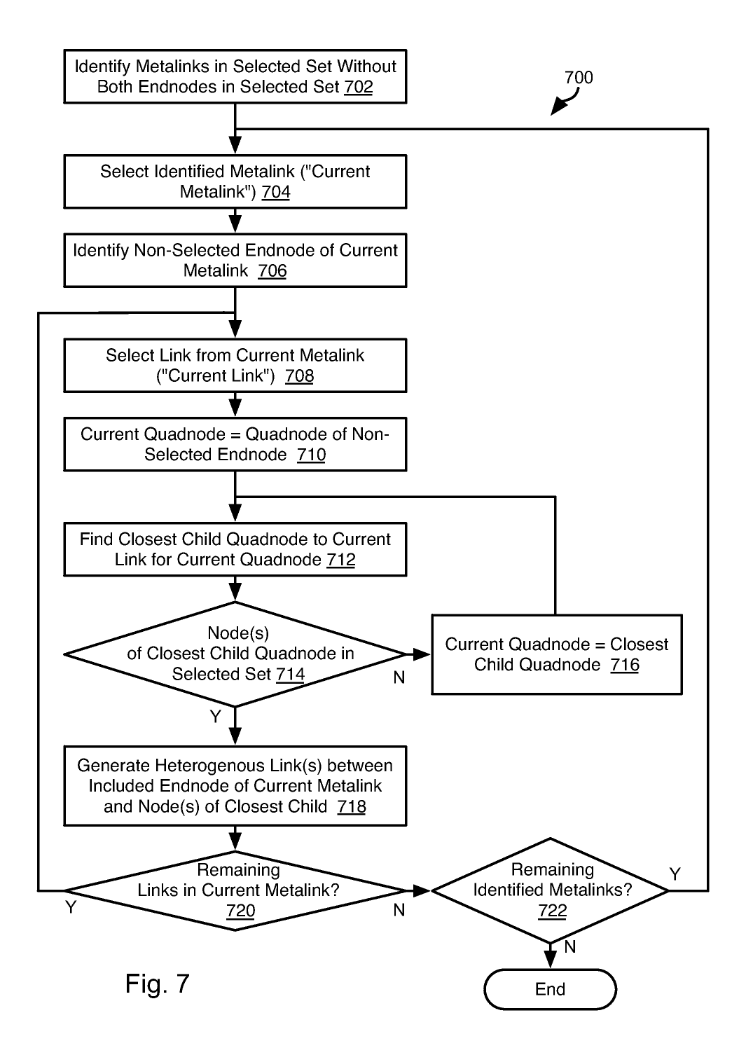

Referring to FIG. 7, the method 500 generates as a result a selected set including some or all of metanodes, network nodes, metalinks and links. Inasmuch as the distance of a given quadnode to the viewer varies across the quadtree, it is likely that a metalink may extend between first and second quadnodes such that a metanode or network nodes of one of the quadnodes is included in the selected set whereas a metanode of network nodes of the second quadnodes were not. Accordingly, the illustrated method 700 may be used to identify this condition and generate heterogeneous links for representing these metalinks. The illustrated method 700 may also be used to associated the links associated with metalinks with nodes (network nodes or metanodes) that are both in the selected set. In particular, the illustrated method 700 may be used to associated spanning links that cross between quadnodes with the nodes associated with these quadnodes or the child quadnodes thereof.

The method 700 may include identifying 702 metalinks in the selected set for which one or more metanodes at the ends thereof (“end nodes”) are not included in the selected set. As illustrated in FIG. 4B and as discussed with respect to the method 300 of FIG. 3, when a metanode is defined for a quadnode, one or more metalinks may also be associated with the quadnode for links that span between pairs of child quadnodes of the quadnode. Accordingly, for a metalink in the selected set and associated with a given quadnode, a metanode or one or more network nodes associated with a child quadnode of the given quadnode that is located at an end point of the metalink may be evaluated. If that metanode or one or more network nodes of this child quadnode are not in the selected set yet a metanode of another child quadnode is in the selected set, that metalink may be identified 702 as a metalink without both endnodes thereof in the selected set. Stated differently, if a metalink is associated with a given quadnode and either of the child quadnodes located at an endpoint of the metalink is not a “viewable quadnode” that was found to be within a level-specific threshold of the viewer, then that metalink is identified 702 as a metalink without both endpoints in the selected set.

From among the metalinks identified at step 702, a metalink may be selected 704 for processing (the “current metalink”). For subsequent processing, a non-selected end node for the metalink may be identified 706. The non-selected end node may be a metanode or a non-viewable quadnode located at an endpoint of the current metalink.

The method 700 may further include selecting a link (the “current link”) associated with the current metalink. As noted above, a metalink may represent multiple spanning links, accordingly each of these links may be processed according to the method 700.

For subsequent processing, “current quadnode” may be set 710 to be the quadnode located at an endpoint of the current metalink, e.g. the non-viewable quadnode at an endpoint of the current metalink. The method 700 may include finding 712 a child quadnode of the current quadnode that is closest to an endpoint of the current link and evaluating 714 whether a node (network or metanode) of the closest child quadnode is in the selected set, if not, the current quadnode is set 716 to be the current quadnode and the method continues at step 712. If one or more nodes of the closest child quadnode is found 714 to be in the selected set, then the method 700 may include generating a heterogeneous link between an included endnode of the current metalink and one or more nodes of the closest child. In instances where both endnodes of a metalink are not in the selected set, the method 700 may include performing steps 708-718 twice for each link associated with the metalink, once for each end of the each link.

In one example, a metalink ML1 has end metanodes M1 and M2 that are not in the selected set. The quadnodes MQ1 and MQ2 for the metanodes M1 and M2, respectively may be identified. Among the children of MQ1 and MQ2, child quadnodes CQ1 and CQ2 are identified that are viewable quadnodes. CQ1 and CQ2 may be at the same or different levels in the quadtree. CQ1 and CQ2 may be identified by executing steps 708-716 starting with MQ1 and MQ2, respectively, as the current quadnode. A heterogeneous link may be generated between a node (network or meta-) associated with CQ1 and a node (network or meta-) associated with CQ2 and that heterogeneous link used to represent visually the metalink ML1 according to methods described herein. Where the metalink ML1 has multiple links associated therewith, it is possible that other pairs of child quadnodes could be identified in a same manner. The other pairs of child quadnodes could include one of CQ1 and CQ2 where the links have an end point located at either of CQ1 or CQ2.

In another example, metalink ML1 has end metanodes M1 and M2. M2 is in the selected set but M1 having associated quadnode MQ1 is not. For each link L1, L2, etc., associated with ML1, a viewable child quadnode CQ1, CQ2, etc., of MQ1 is identified (such as according to steps 708-716) that is closest to at an end point of the link L1, L2, etc. A heterogeneous link is then generated for each link L1, L2, etc. that has as one end point metanode M2 and as the other end point one or more nodes (network or meta-) associated with the corresponding identified child quadnode CQ1, CQ2, etc.

For example, a heterogeneous link may have one end point at a location of a metanode associated with the closest child and another end point at a metanode in the selected set associated with an endpoint of the current metalink. In another example, a heterogeneous link may have at one end point a network node that is both associated with the closest child and located at an end point of the current link and as another point the metanode in the selected set associated with an endpoint of the current metalink, e.g. an immediate child quadnode of the quadnode with which the current metalink is associated.

By adding metalinks to the selected set and using the location of the endpoints to limit the quadnodes evaluated when traversing the quadtree, less computation is required to determine the appropriate metanode or network nodes that are in the selected set but located at a deeper level of the quadtree.

The method 700 may include evaluating 720 whether any links associated with the current metalink have not been processed, if so the method 700 continues at step 708 with another link associated with the current metalink. If not, the method 700 may include evaluating 722 whether any of the metalinks identified at step 702 remain to be processed, if so, the method 700 may continue at step 704. If no more metalinks remain to be processed, the method 700 may end.

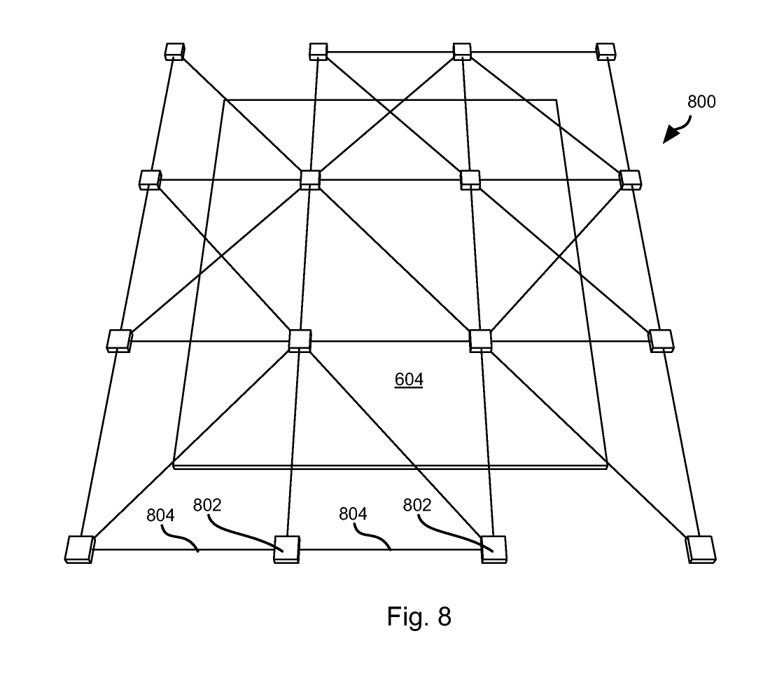

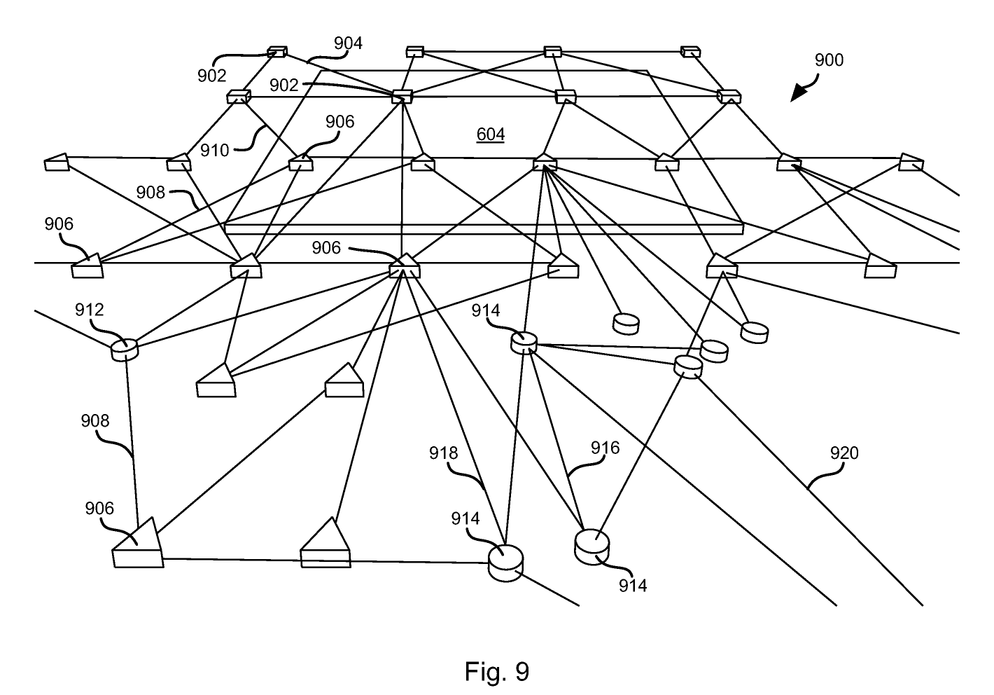

Any nodes, metanodes, links, and metalinks as well as any heterogeneous links may then be rendered for display on a display device, transmitted for display, or stored for later use. Examples of graphical representation of a network according to the methods disclosed herein are shown in FIGS. 8 and 9.

Referring to FIG. 8, the top level representation 800 of a network topology may include a plurality of metanodes 802 and metalinks 804 between metanodes 802. In the illustrated representation 800 all of the metanodes 802 and metalinks 804 therebetween are for the same level of detail. As is also shown in FIG. 8, a rectangular ground plane 604 may be shown from the perspective of the viewpoint 500 in order to aid in visualization of the network topology.

FIG. 9 illustrates an example graphical representation 900 of a network topology such as may be generated according to the methods disclosed herein. As is apparent in FIG. 9, nodes 902 (shown as square shapes) located at greatest distance are represented using the lowest level of detail, including the metalinks 904 therebetween (e.g. the same as shown in FIG. 8). Nodes 906 (shown as triangles) at an intermediate distance from the point of view are represented at an intermediate level of detail, in which the lowest detail level representation is replaced with a greater number of nodes 906 and the connections 908 between them corresponding to that level of detail. As shown in FIG. 9, heterogeneous links 910 are generated and displayed between some of the intermediate nodes 906 and the top level metanodes 902.

In some instances a node 912 may not represent a cluster of other nodes, i.e. represents an individual node of the network. However, where such a node 912 is isolated or distanced from other nodes, a level of detail other than the highest level may represent that node as an individual node rather than as a metanode. Accordingly, a connection from a node 906 to such a node 912 may be a connection 908 defined for that level of detail rather than a heterogeneous link generated according to the methods disclosed herein.

A highest level of detail may include nodes 914 connected by links 916. The nodes 914 of the lowest level represent actual network nodes of the network topology and links 916 represent actual network connections between individual nodes. Links 916 may represent logical connections, physical wires, or wireless connections between individual nodes.

The highest level nodes 914 may be connected to intermediate nodes 912 by means of heterogeneous links 918 generated according to the methods described herein. In the graphical representation 900, only three levels of detail are shown. However, any number of levels of detail may be simultaneously shown in a single graphical representation 900 with heterogeneous links among nodes for different levels of detail, including non-contiguous levels of detail. In addition, a heterogeneous connection may span multiple levels, e.g. connect a lowest level node to a highest level node, depending on which nodes are selected for representation.

As shown in FIG. 9, some nodes may be outside of the field of view and links 920 extending beyond the field of view may be partially represented and may represent in-level connections or heterogeneous connections as generated according to the methods disclosed herein.

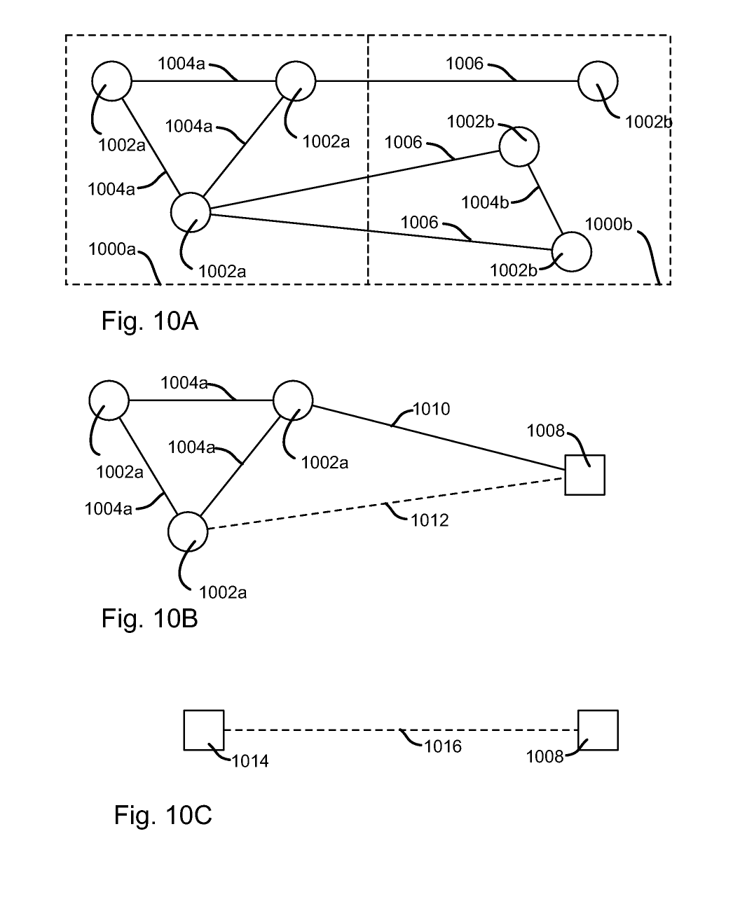

FIGS. 10A through 10C illustrate methods that may be used to generate and represent heterogeneous links. Referring specifically to FIG. 10A, a cluster 100a of nodes corresponding to an upper level quadnode and a cluster 100b of nodes corresponding to another upper level quadnode may be as illustrated. The cluster 1000a may include a number of nodes 1002a and connections 1004a (links or metalinks) between nodes 1002a. The cluster 1000b may also include a number of nodes 1002b and connections 1004b between nodes 1002b. The nodes 1002a, 1002b may be metanodes or individual nodes of a network topology. One or more additional connections 1006 may exist that connect one or more nodes 1002a to nodes 1002b.

Referring to FIG. 10B, in some graphical representations generated according to methods described herein, the cluster 1000b may be represented by a single upper level node 1008 (e.g. metanode), whereas the nodes 1002a are included in the graphical representation. Accordingly, a heterogeneous link 1010 may represent an individual connection 1006 between a node 1002a and a node 1002b. In some embodiments, links, heterogeneous or otherwise, may be visually distinguished based on the number of connections the link represents. For example, the link 1012 represents two links 1006 spanning between a node 1002a and two different nodes 1002b. Accordingly, the link 1012 may be visually distinguished by means of color, line type, accompanying text, or some other feature from the link 1010 that represents a single underlying link 1006.

Referring to FIG. 10C, in still other graphical representations, both clusters 1000a, 1000b may be represented by upper level nodes 1008, 1014. Accordingly, an upper level link 1016 may represent all of the spanning links 1006 and may have a line type or other visual indicator as described above indicating that the link represents multiple links.

The systems and methods described herein advantageously enable the rapid rendering of a network that includes representations of different portions of the network with different levels of detail. The methods disclosed herein further enable this functionality with relatively low computing requirements. For example, creating a quadtree according to the method 300 of FIG. 3 is on the order of complexity O(n*log(n)) for a typical network of O(n) nodes and from 3n to 4n links between nodes. Likewise, determining a selected set of nodes, metanodes, links and metalinks according to the method 500 of FIG. 5 is on the order of O(n/[2̂(log(n)/2)]). The method 500 will typically return m objects, on the order of O(n/[2̂(log(n)/2)]. For a selected set of m objects output from the method 500, the processing time required to generate heterogeneous links is on the order of O(m log(m)), however for most real networks the actual complexity is much lower.

The present invention may be embodied in other specific forms without departing from its spirit or essential characteristics. For example, although visualization of a network topology is disclosed, any representation of interconnected elements may be visualized according to methods disclosed herein. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A computer system including one or more processors and one or more memory devices operably coupled to the one or more processors, the one or more memory devices storing executable and operational data effective to cause the one or more processors to perform a method including:
providing a network representation including a plurality of network nodes and a plurality of links connecting pairs of network nodes of the plurality of network nodes, each of the network nodes having a position associated therewith;
generating a quadtree representation of the network representation, the quadtree including a root node and a plurality of quadnodes arranged in a hierarchy beneath the root node such that the root node and quadnodes each represent a quad area, the quad area represented by each quadnode being a portion of the quad area of a parent in the hierarchy and the quad area of the root node encompassing at least a portion of the positions associated with the network nodes, wherein generating the quadtree representation includes processing at least one of the root node and quadnodes as a current quadnode by:
a) identifying at least one spanning link of the plurality of links that extends across multiple immediate children quadnodes of the current quadnode;
b) generating a metanode representing a portion of the network nodes of the plurality of network nodes located within the quad area of the current quadnode;
c) associating the spanning link and metanode with the current quadnode; and
d) distributing the portion of the network nodes of the plurality of network nodes located within the current quadnode to the immediate children quadnodes of the current quadnode in the quadtree as well as any non-spanning links of the plurality of links associated with the portion of the network nodes, the non-spanning links being located completely within the quad area of an individual immediate child quadnode of the current quadnode.

2. The computer system of claim 1, wherein the executable and operational data is further effective to cause the one or more processors to process the at least one of the root node and quadnodes as the current quadnode by:
e) determining that a number of the portion of the plurality of network nodes within the quad area of the current quadnode exceeds a maximum node count; and
performing steps a through d in response to the determining that the number of the portion of the plurality of network nodes within the quad area of the current quadnode exceeds the maximum node count.

3. The computer system of claim 2, wherein the executable and operational data is further effective to cause the one or more processors to process the at least one of the root node and quadnode as the current quadnode by:
determining that the immediate children of the current quadnode are at or above a maximum depth from the root node; and
performing steps a through e with respect to the immediate children of the current quadnode.

4. The computer system of claim 2, wherein a number of child nodes of each of the root node and quadnodes of the quadtree is equal to the maximum node count.

5. The computer system of claim 4, wherein the maximum node count is four.

6. A method for representing a network including a plurality of network nodes and a plurality of links connecting pairs of network nodes of the plurality of network nodes, each of the network nodes having a position associated therewith, the method comprising:
generating a quadtree representation of the network representation, the quadtree including a root node and a plurality of quadnodes arranged in a multi-level hierarchy beneath the root node such that the root node and quadnodes each represent a quad area, the quad area represented by each quadnode being a portion of the quad area of a parent in the hierarchy and the quad area of the root node encompassing at least a portion of the positions associated with the network nodes; and
generating an association between the plurality of network nodes and the quadtree, wherein each node of the root node and plurality of quadnodes has associated therewith one of:
(a) a portion of the network nodes of the plurality of network nodes having a position within the quad area the each node and any links of the plurality of links associated exclusively within the portion of the network nodes; and
(b) a metanode representing a portion of the network nodes of the plurality of nodes having a position within the quad area of the each node and one or more metalinks, each metalink representing one or more links of the plurality of links spanning between a pair of child quadnodes of the each node and having as endpoints thereof the pair of child quadnodes.

7. The method of claim 6, further comprising:
identifying from the quadtree, a set of viewable nodes, wherein each viewable node is one of the root node and a quadnode of the plurality of quadnodes and has the quad area thereof meeting a threshold criteria with respect to a location of a viewpoint, the threshold criteria corresponding to a level of the each viewable node within the multi-level hierarchy, the threshold criteria decreasing with depth in the multi-level hierarchy below the root node; and
adding network nodes, metanodes, links, and metalinks associated the viewable nodes to a selected set.

8. The method of claim 7, further comprising:
identifying in the selected set at least one metalink in the selected set having as at least one endpoint one or more first quadnodes that are not in the set of viewable nodes; and
for each quadnode of the one or more first quadnodes identifying at least one of one or more network nodes and one or more metanodes that are associated with a descendent quadnode of the each quadnode, are in the selected set, and are associated with the one or more links of the identified at least one metalink; and
generating one or more heterogeneous links having as one or more endpoints thereof the identified at least one of one or more network nodes and one or more metanodes for the one or more first quadnodes.

9. The method of claim 8, further comprising generating a graphical representation of the network including graphical representations of the network nodes, metanodes, links, and metalinks of the selected set and the heterogeneous links.

10. The method of claim 9, wherein generating the graphical representation of the network further comprises generating graphical representations of heterogeneous links that are visually distinguishable from graphical representations of both of the links and metalinks.

11. The method of claim 9, wherein generating the graphical representation of the network further comprises generating a representation of first metalinks having multiple links associated therewith that are visually distinguishable from graphical representations of second metalinks having only one link associated therewith.

12. The method of claim 9, wherein generating the graphical representation of the network further comprises generating graphical representations of metanodes that are visually distinguishable from graphical representations of network nodes.

13. The method of claim 8, wherein identifying the at least one of one or more network nodes and one or more metanodes that are in the selected set and associated with the one or more links of the identified at least one metalink further comprises, for each link of the one or more links of the identified at least one metalink:
setting as a current node a viewable node with which the at least one metalink is associated;
repeating until a network node or metanode in the selected set is found among the child quadnodes of the current node:
(a) identifying a closest child node in the quadtree of the current node with which the metalink is associated, the closest child node having a quad area including an end point of the each link; and
(b) determining that the closest child node does not have a node or metanode of the selected set associated therewith; and
(c) setting the current node to be the closest child node.

14. The method of claim 13, wherein:
each of the root node and plurality of quadnodes has a center location associated therewith;
identifying the closest child node in the quadtree of the current node further comprises identifying as the closest child node a child node of the current node having a center location closest to the end point of the each link.

15. The method of claim 6, wherein the positions associated with each of the network nodes lie within a two dimensional plane.

16. The method of claim 6, wherein the positions associated with each of the network nodes correspond to geographic locations of network devices.

17. A non-transitory computer program product storing executable and operational data that, when executed, are operable to cause a processor to perform a method including:
receiving a network topology, the topology including a plurality of network nodes and a plurality of links connecting pairs of network nodes of the plurality of network nodes, each of the network nodes having a position associated therewith;
generating a quadtree representation of the network topology, the quadtree including a root node and a plurality of quadnodes arranged in a multi-level hierarchy beneath the root node such that the root node and quadnodes each represent a quad area, the quad area represented by each quadnode being a portion of the quad area of a parent in the hierarchy and the quad area of the root node encompassing at least a portion of the positions associated with the network nodes;
generating an association between the plurality of network nodes and the quadtree, wherein each quadnode of the root node and plurality of quadnodes has associated therewith one of:
(a) a portion of the network nodes of the plurality of network nodes having a position within the quad area of the each quadnode and any links of the plurality of links associated exclusively within the portion of the network nodes; and
(b) a metanode representing a portion of the network nodes of the plurality of nodes having a position within the quad area of the each quadnode and one or more metalinks, each metalink representing one or more links of the plurality of links spanning between a pair of child quadnodes of the each quadnode and having as endpoints thereof the pair of child quadnodes;
identifying from the quadtree, a set of viewable nodes, wherein each viewable node is one of the root node and a quadnode of the plurality of quadnodes and has the quad area thereof meeting a threshold criteria with respect to a location of a viewpoint, the threshold criteria corresponding to a level of the each viewable node within the multi-level hierarchy, the threshold criteria decreasing with depth in the multi-level hierarchy below the root node;
adding network nodes, metanodes, links, and metalinks associated the viewable nodes to a selected set;
identifying in the selected set at least one metalink in the selected set having at one or more end points thereof one or more first quadnodes that are not in the set of viewable nodes and as another endpoint a second quadnode this is in the set of viewable nodes;
identifying at least one of one or more network nodes and one or more metanodes that are in the selected set and associated with the one or more links of the identified at least one metalink; and
generating, for each of the one or more links of each identified at least one metalink one or more heterogeneous links between one of
a metanode associated with a second quadnode that is at an endpoint of the each identified at least one metalink and the identified at least one of one or more network nodes and one or more metanodes associated with the each of the one or more links
and a pair of the identified at least one of one or more network nodes and one or more metanodes located at ends of the each of the one or more links.

18. The computer program product of claim 17, further comprising executable and operational data effective to, when executed, cause a processor to generate a graphical representation of the network including graphical representations of the network nodes, metanodes, links, and metalinks of the selected set and the heterogeneous links.

19. The computer program product of claim 18, wherein generating the graphical representation of the network further comprises generating graphical representations of heterogeneous links that are visually distinguishable from graphical representations of both of the links and metalinks.

20. The method of claim 9, wherein generating the graphical representation of the network further comprises generating a representation of first metalinks having multiple links associated therewith that are visually distinguishable from graphical representations of second metalinks having only one link associated therewith.
